(19) United States
(12) Patent Application Publication
(10) Pub. No.: US 2025/0034939 A1
(43) Pub. Date: Jan. 30, 2025

(54) ROLLER TUBE ASSEMBLY HAVING ADJUSTABLE TORQUE

(71) Applicant: Draper, Inc., Spiceland, IN (US)

(72) Inventor: Adam S. Timmins, Noblesville, IN (US)

(21) Appl. No.: 18/226,300

(22) Filed: Jul. 26, 2023

(51) Int. Cl. E06B 9/72; E06B 9/44; E06B 9/80

(52) U.S. Cl. CPC E06B 9/72; E06B 9/44; E06B 9/80; E06B 2009/801

(57) ABSTRACT

A roller tube assembly for supporting a window covering between a first window covering bracket and a second window covering bracket may comprise a roller tube adapted to have the window covering rolled onto to raise the window covering and rolled off of to lower the window covering, a torque generator coupled to the roller tube and including a plurality of biasing members positioned within the roller tube, a torque adjustment input operatively coupled to the torque generator and including an operator actuatable input engageable from outside of an envelope of the roller tube, a first mount supporting a first end of the roller tube and adapted to be removably coupled to the first window covering bracket, and a second mount supporting a second end of the roller tube and adapted to be removably coupled to the second window covering bracket. The roller tube, the torque generator, the torque adjustment input, the first mount, and the second mount may be a preassembled unit that is adapted to be coupled to the first window covering bracket and the second window covering bracket.

### FIELD OF THE DISCLOSURE

The present disclosure relates to window covering systems. More particularly, the present disclosure relates to covering systems having an adjustable torque generator.

### BACKGROUND OF THE DISCLOSURE

Window covering systems, such as roller shades, are movable between open and closed positions and intermediate positions. Window covering systems may be motorized or manually operated. Some manually operated roller shade systems include internal torque generators which maintain the shade material of the roller shade in a desired position. It is desired to be able to adjust the amount of torque provided by the internal torque generator.

### SUMMARY OF THE DISCLOSURE

In an exemplary embodiment of the present disclosure, a roller tube assembly for supporting a window covering between a first window covering bracket and a second window covering bracket is provided. The roller tube assembly comprising: a roller tube adapted to have the window covering rolled onto to raise the window covering and rolled off of to lower the window covering; a torque generator coupled to the roller tube and including a plurality of biasing members positioned within the roller tube; a torque adjustment input operatively coupled to the torque generator and including an operator actuatable input engageable from outside of an envelope of the roller tube; a first mount supporting a first end of the roller tube and adapted to be removably coupled to the first window covering bracket; and a second mount supporting a second end of the roller tube and adapted to be removably coupled to the second window covering bracket. The roller tube, the torque generator, the torque adjustment input, the first mount, and the second mount are a preassembled unit that is adapted to be coupled to the first window covering bracket and the second window covering bracket.

In an example thereof, the torque adjustment input is positioned between a first extreme outer end of the first mount and a second extreme outer end of the second mount.

In another example thereof, the torque adjustment input is positioned proximate the first mount and the first mount includes a plurality of spaced part interfaces which cooperate with corresponding spaced apart interfaces on the first window covering bracket. In a variation thereof, each of the plurality of spaced apart interfaces of the first mount are in a non-intersecting relationship with a longitudinal axis of the roller tube.

In a further example thereof, the torque adjustment input comprising: a base coupled to the first mount; an adjuster including the operator actuatable input rotatable relative to the base; an output operatively coupled to the plurality of biasing members of the torque generator and rotatable relative to the base; and a lock movable by the adjuster between an unlocked position wherein the output is rotatable relative to the base and a locked position wherein the output is held relative to the base.

In a variation thereof, one of the base and the output includes a radial surface engaged by the lock when the lock is in the locked position and the other of the base and the output includes at least one stop engaged by the lock in the unlocked position. In a further variation thereof, the at least one stop engaged by the lock in the locked position to hold a position of the output relative to the base.

In another variation thereof, the adjuster includes a wheel surrounding the longitudinal axis of the roller tube, an outer circumference of the wheel being the operator actuatable input and an actuator carried by the wheel, the actuator engaging the lock to move the lock from the locked position to the unlocked position. In a further variation thereof, the lock includes a torsion spring positioned about the base, the torsion spring having a sprung configuration corresponding to the unlocked position wherein the torsion spring is rotatable relative to the base and an unsprung configuration corresponding to the locked position wherein the torsion spring is held stationary relative to the base.

In yet another variation thereof, the roller tube assembly further comprising a carriage which supports the plurality of biasing members of the torque generator. The output of the torque adjustment input includes an elongated shaft which extends through the carriage and is operatively coupled to the plurality of biasing members of the torque generator within a longitudinal extent of the carriage and a support wheel coupled to the elongated shaft and including at least one stop surface engageable by the lock. In a further variation thereof, the carriage is rotatable with the roller tube relative to the torque adjustment input. In still a further variation thereof, the base includes a radial surface engaged by the lock when the lock is in the locked position and the at least one stop of the support wheel of the output is engaged by the lock in both the unlocked position and the locked position, in the locked position the at least one stop holds a position of the output relative to the base. In still a further variation thereof, the adjuster includes a wheel surrounding the longitudinal axis of the roller tube, an outer circumference of the wheel being the operator actuatable input and an actuator carried by the wheel, the actuator engaging the lock to move the lock from the locked position to the unlocked position. In yet still a further variation thereof, the lock includes a torsion spring positioned about the base, the torsion spring having a sprung configuration corresponding to the unlocked position wherein the torsion spring and the output are rotatable relative to the base and an unsprung configuration corresponding to the locked position wherein the torsion spring and the output are held stationary relative to the base. In still yet a further variation thereof, the roller tube assembly further comprising a travel limiter coupled to the roller tube. The travel limiter including a threaded shaft received in the roller tube, a stop coupled to the threaded shaft, and a traveling stop threadably engaged with the threaded shaft and coupled to the roller tube to rotate with the roller tube. In still yet a further variation thereof, the threaded shaft is coupled to the torque adjustment input and rotatable with the output of the torque adjustment input.

In a further exemplary embodiment, a method of installing the roller tube assembly of any of the disclosed roller tube assemblies is provided. The method comprising the steps of: coupling the first mount to the first window covering bracket, the first mount being non-rotatable relative to the first window covering bracket; coupling the second mount to the second window covering bracket; and removing a retainer holding a position of a first portion of the roller tube assembly coupled to a first end of the plurality of biasing members relative to a second portion of the roller tube assembly coupled to a second end of the plurality of biasing members.

In an example thereof, the method further comprising the step of adjusting a torque level of the torque generator relative to the roller tube. In a variation thereof, the step of adjusting the torque level of the torque generator relative to the roller tube includes the step of moving the operator actuatable input relative to the roller tube. In another variation thereof, the step of moving the operator actuatable input relative to the roller tube includes the step of rotating the operator actuatable input relative to the roller tube.

### BRIEF DESCRIPTION OF THE DRAWINGS

The above-mentioned and other features and advantages of this disclosure, and the manner of attaining them, will become more apparent and will be better understood by reference to the following description of exemplary embodiments taken in conjunction with the accompanying drawings, wherein:

FIG. 1 illustrates a diagrammatic view of a roller tube assembly of the present disclosure including a torque generator and a torque adjustment input;

FIG. 2A illustrates a perspective view of an exemplary embodiment of roller tube assembly of FIG. 1 coupled to a pair of internal mount brackets;

FIG. 2B illustrates a perspective view of another exemplary embodiment of roller tube assembly of FIG. 1 coupled to a pair of external mounts;

FIG. 2C illustrates a detail view of the exemplary embodiment of a portion of the roller tube assembly and one end bracket of FIG. 2A;

FIG. 2D illustrates a detail view of the exemplary embodiment of a portion of the roller tube assembly and one end bracket of FIG. 2B;

FIG. 3 illustrates a partial exploded perspective view of the roller shade system of FIG. 2A illustrating an exemplary torque generator, an exemplary torque adjustment input, and an exemplary travel limiter along with one of the internal mount brackets;

FIG. 4 illustrates a sectional view of an assembly of the travel limiter, torque generator, and torque adjustment input along lines 4-4 in FIG. 3 coupled to one of the internal mount brackets;

FIG. 5 illustrates a perspective end view of the internal mount bracket with the assembly of the travel limiter, torque generator, and torque adjustment input coupled thereto;

FIG. 6A illustrates a first perspective view of the assembly of the travel limiter, torque generator, and torque adjustment input of FIG. 3;

FIG. 6B illustrates a second perspective view of the assembly of the travel limiter, torque generator, and torque adjustment input of FIG. 6A;

FIG. 7 illustrates an exploded view of the assembly of the travel limiter, torque generator, and torque adjustment input;

FIG. 8 illustrates a sectional view of the assembly of the travel limiter, torque generator, and torque adjustment input along lines 8-8 in FIG. 6A;

FIG. 9 illustrates an exploded perspective view of the torque adjustment input of FIG. 3;

FIG. 10 illustrates a sectional view of the torque adjustment input of FIG. 3 along lines 10-10 of FIG. 6A with the torque adjustment input in a first, hold configuration;

FIG. 11 illustrates the sectional view of FIG. 10 with the torque adjustment input in a second, adjust configuration; and

FIG. 12 illustrates an exemplary lower hem bar of the exemplary shade of FIG. 2A and associated adjustment tool.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

In some instances throughout this disclosure and in the claims, numeric terminology, such as first, second, third, and fourth, is used in reference to various components, inputs, and other items. Such use is not intended to denote an ordering of the components. Rather, numeric terminology is used to assist the reader in identifying the component being referenced and should not be narrowly interpreted as providing a specific order of components.

The terms “couples”, “coupled”, “coupler” and variations thereof are used to include both arrangements wherein the two or more components are in direct physical contact and arrangements wherein the two or more components are not in direct contact with each other (e.g., the components are “coupled” via at least a third component), but yet still cooperate or interact with each other.

The present disclosure is directed to roller tube assemblies for supporting a window covering between a first window covering bracket and a second window covering bracket. Exemplary window coverings include fabrics, pleated blinds, and other suitable materials that may be rolled onto and off of a roller tube. Exemplary roll tube assemblies may comprise a roller tube adapted to have the window covering rolled onto to raise the window covering and rolled off of to lower the window covering, a torque generator coupled to the roller tube and including a plurality of biasing members which may be positioned within the roller tube, a torque adjustment input operatively coupled to the torque generator and including an operator actuatable input engageable from outside of an envelope of the roller tube, a first mount supporting a first end of the roller tube and adapted to be removably coupled to the first window covering bracket, and a second mount supporting a second end of the roller tube and adapted to be removably coupled to the second window covering bracket. In embodiments, the roller tube, the torque generator, the torque adjustment input, the first mount, and the second mount may be a preassembled unit that is adapted to be coupled to the first window covering bracket and the second window covering bracket.

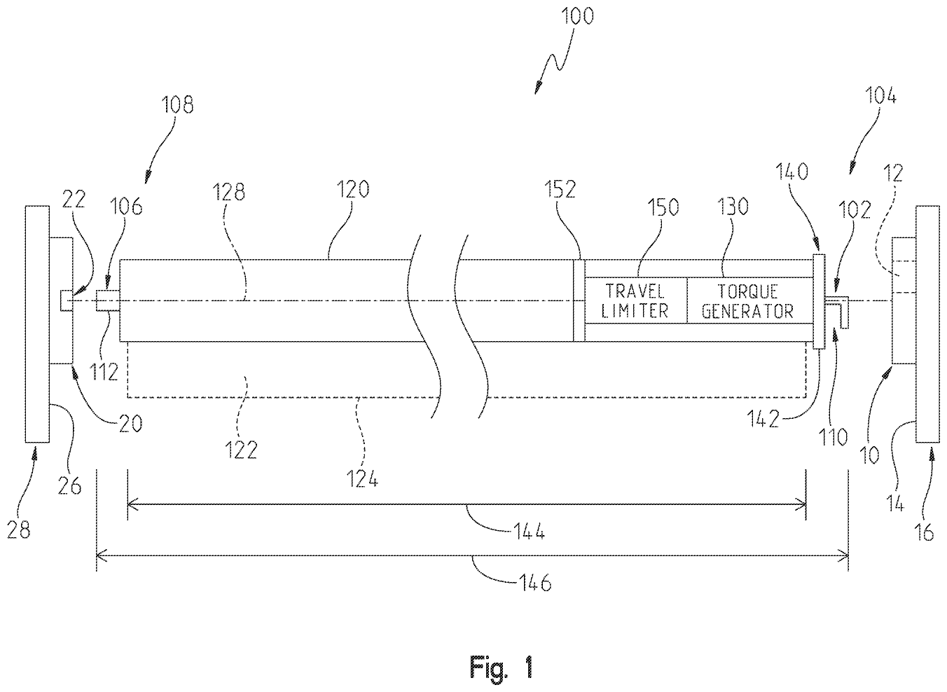

Referring to FIG. 1, an exemplary roller tube assembly 100 is shown. Roller tube assembly 100 includes a first mount 102 on a first end 104 of roller tube assembly 100 and a second mount 106 on a second end 108 of roller tube assembly 100, the second end 108 being opposite the first end 104. First mount 102 includes at least one interface 110 which cooperates with at least one interface 12 of a first window covering bracket 10 that is coupled to a surface 14 of the environment and second mount 106 includes at least one interface 112 which cooperates with at least one interface 22 of a second window covering bracket 20 that is coupled to a surface 26 of the environment. Surfaces 14, 26 may be wall 16, 28 of a window encasement. Further, first window covering bracket 10 and second window covering bracket 20 may be a top mount which mounts to a ceiling or upper wall of the a window encasement. Additionally, first window covering bracket 10 and second window covering bracket 20 may be a front mount that attaches to a wall forward of the window. Although not shown, first window covering bracket 10 and second window covering bracket 20 may be covered by a facia.

As illustrated, at least one interface 112 is a shaft that is received in a receiver in second window covering bracket 20 and at least one interface 110 is a hook which is received in a slot in first window covering bracket 10. Other exemplary interfaces include fasteners and threaded apertures, mating shapes, and other suitable shapes for coupling first mount 102 and first end 104 to the respective one of first window covering bracket 10 and second window covering bracket 20. In embodiments, first end 104 is rotatable relative to at least one interface 22 while first mount 102 is held stationary relative to first window covering bracket 10.

Roller tube assembly 100 further includes a roller tube 120 adapted to have a window covering 122 rolled onto to raise the window covering when the roller tube 120 is rotated in a first direction and rolled off of to lower the window covering when roller tube 120 is rotated in a second direction opposite the first direction.

Roller tube assembly 100 additionally includes a torque generator 130 coupled to the roller tube 120. Torque generator 130 is configured to hold lower end 124 of window covering 122 in a desired position when lower end 124 of window covering 122 is lowered, such as with an operator's hand or a tool held by the operator. In embodiments, torque generator 130 provides a counterbalance force to the weight of the hanging portion of window covering 122.

Torque generator 130, in embodiments, includes one or more biasing members which provide the counterbalance force. Exemplary biasing members include compression springs, clock springs, and torsion springs. In embodiments, torque generator 130 includes a plurality of biasing members. The one or more biasing members of torque generator 130 may be positioned within an interior of roller tube 120. In one embodiment of torque generator 130, a plurality of clock springs are positioned along a longitudinal axis 128 of roller tube 120. Torque generator 130 on one end is held stationary with first mount 102 and hence with first window covering bracket 10 when roller tube assembly 100 is assembled to first window covering bracket 10 and on another end is coupled with roller tube 120. As lower end 124 of window covering 122 is lowered the torque generated by torque generator 130 increases and as lower end 124 of window covering 122 is raised the torque generated by torque generator 130 decreases.

Roller tube assembly 100 includes a torque adjustment input 140 which is operatively coupled to torque generator 130. Torque adjustment input 140 includes an operator actuatable input 142 engageable from outside of an envelope 144 of roller tube 120. In embodiments, torque adjustment input 140 is further positioned between a first extreme outer end of first mount 102 and a second extreme outer end of second mount 106, represented by line 146. Torque adjustment input 140 may be adjusted to either add torque to torque generator 130 or remove torque from torque generator 130. An advantage of including torque adjustment input 140, among others, is to allow an adjustment of the torque of torque generator 130 as roller tube assembly 100 ages and the characteristics of the biasing members of torque generator 130 change. As shown in FIG. 1, roller tube 120, at least one interface 110, at least one interface 112, torque generator 130, and torque adjustment input 140 are a preassembled unit that is adapted to be coupled to the first window covering bracket 10 and the second window covering bracket 20.

In embodiments, roller tube assembly 100 further includes a travel limiter 150 which has a first portion held stationary with first mount 102 and a second portion which rotates with roller tube 120. Travel limiter 150 sets a lower limit of lower end 124 of window covering 122 and, optionally, an upper limit of lower end 124 of window covering 122. An advantage, among others of including travel limiter 150 is to protect the biasing members of torque generator 130 from being over sprung. An end of travel limiter 150 is supported by a tube support 152 which engages with an internal profile of roller tube 120.

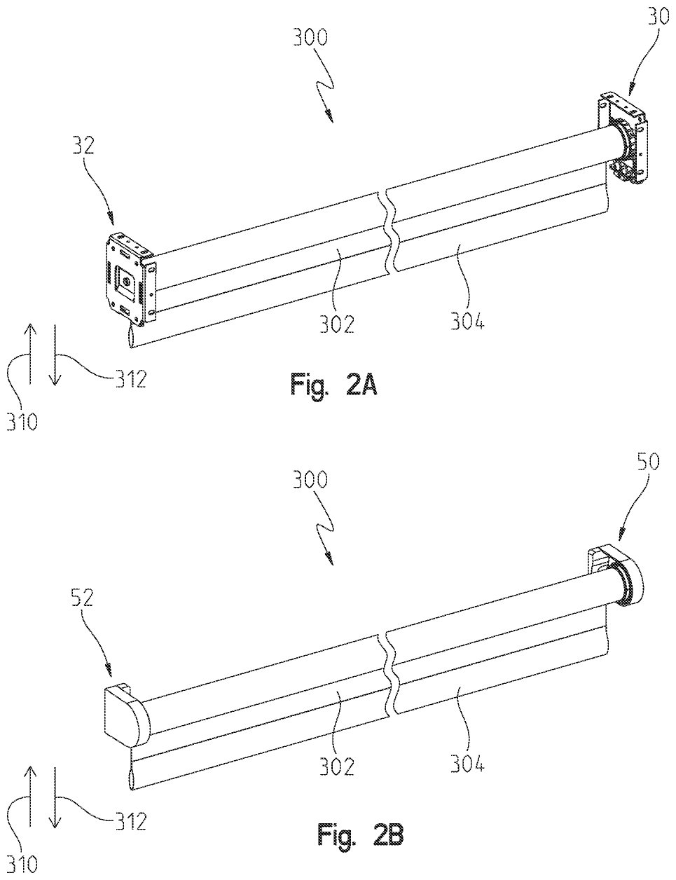

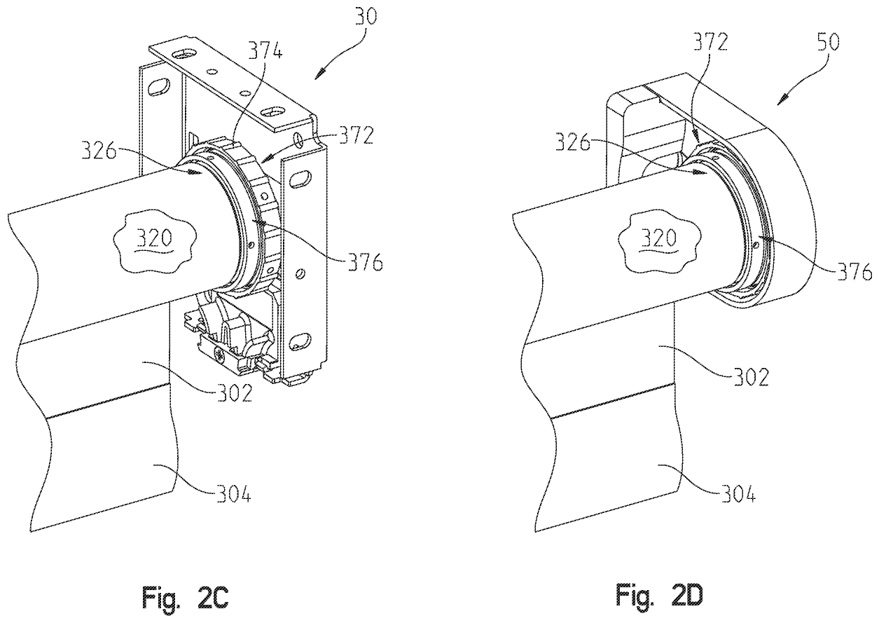

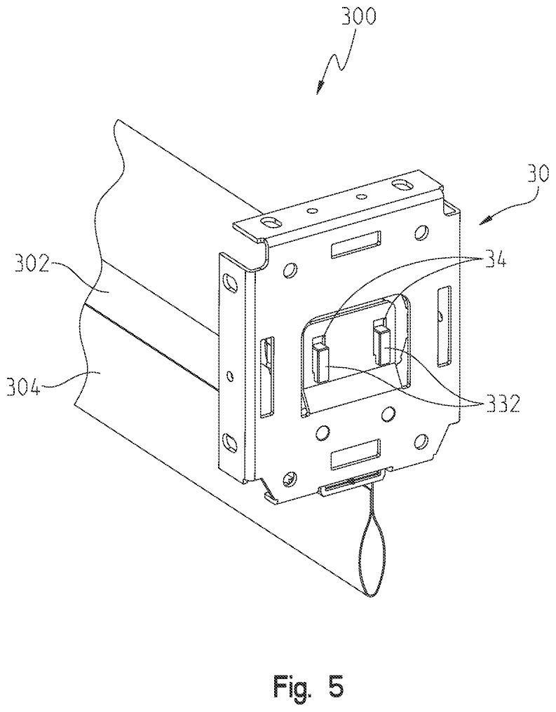

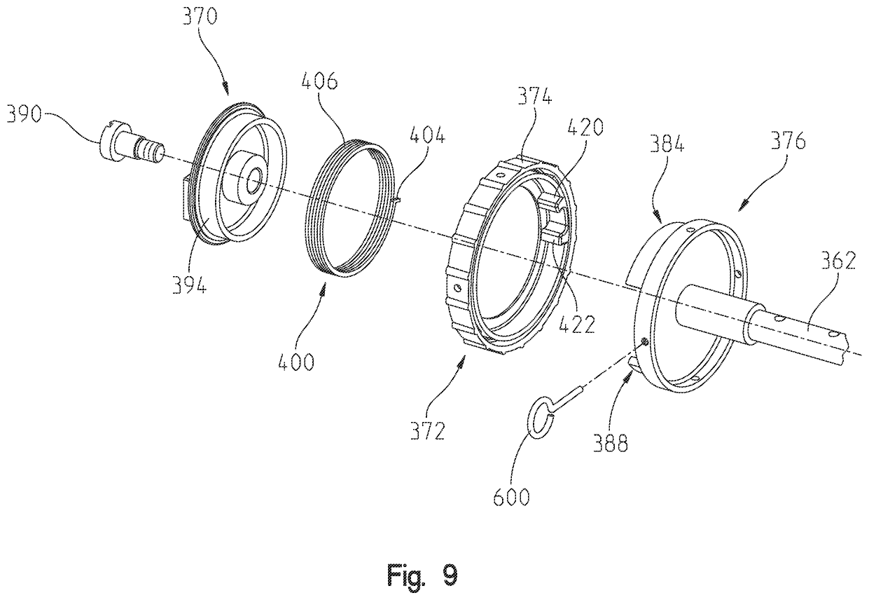

Referring to FIGS. 2A-11, an exemplary roller tube assembly 300 is shown. Roller tube assembly 300 supports a window covering 302 having a lower hem bar 304 (see FIGS. 2A and 2B). Window covering 302 may be raised in direction 310 and lowered in direction 312. Referring to FIG. 2A, roller tube assembly 300 is mounted to a first mount 30 and a second mount 32. Each of first mount 30 and second mount 32 are examples of internal mounts that may be mounted along a top side to a horizontal surface with fasteners (not shown) or mounted along a rear side to a vertically extending wall with fasteners (not shown). In embodiments, a facia may extend from first mount 30 to second mount 32. Referring to FIG. 2B, roller tube assembly 300 is mounted to a first mount 50 and a second mount 52. Each of first mount 50 and second mount 52 are examples of external mounts that may be mounted along a rear side to a vertically extending wall with fasteners (not shown) and which include decorative ends.

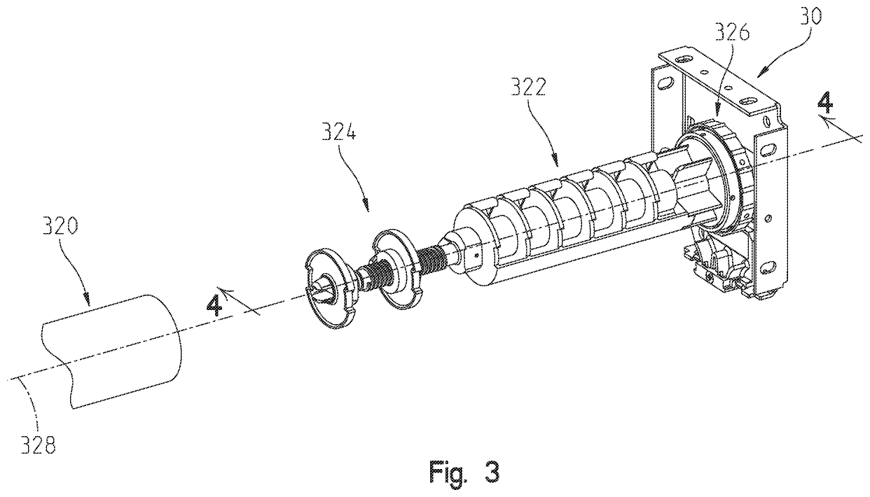

Referring to FIG. 3, roller tube assembly 300 includes a roller tube 320 into an interior of which a torque generator 322 and a travel limiter 324 are inserted. A torque adjustment input 326 extends from a first end of roller tube 320 (see FIG. 2C).

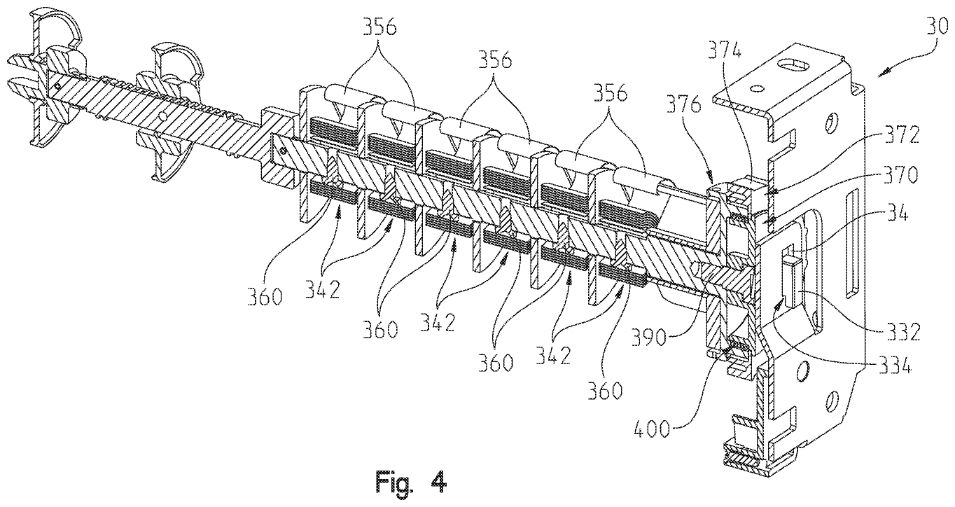

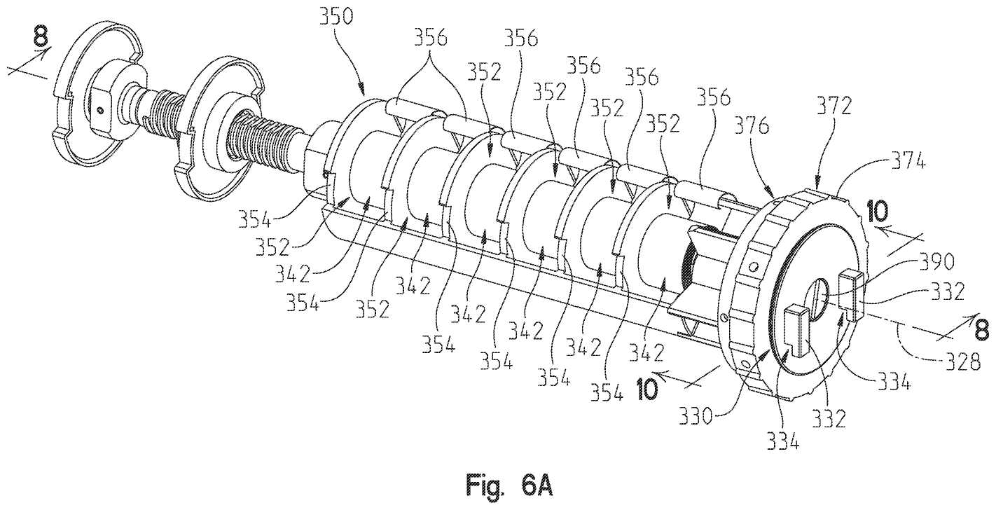

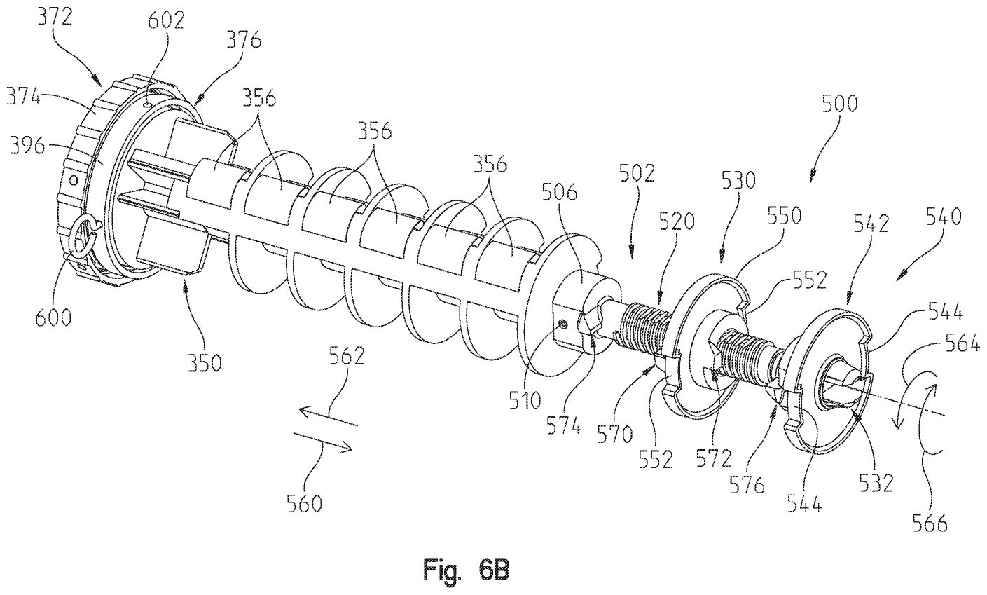

Referring to FIG. 6A, roller tube assembly 300 further includes a first mount 330 having a plurality of spaced apart interfaces 332 which couple to first mount 30 (see FIG. 4). In the illustrated embodiment, each of the spaced apart interfaces 332 are hooks 334 which are received in corresponding slots 34 of first mount 30. As shown in FIG. 6A, each of spaced apart interfaces 332 are in a non-intersecting relationship with a longitudinal axis 328 of roller tube assembly 300. By having multiple interfaces 332 with at least one spaced apart from longitudinal axis 328, first mount 330 is held stationary relative to first mount 30 while roller tube 320 of first mount 330 rotates. An advantage, among others, of having each of spaced apart interfaces 332 equidistant from longitudinal axis 328 is the balancing of the load of roller tube 320 on first mount 330. In embodiments, roller tube assembly 300 includes a second mount, like mount 104, to mount roller tube assembly 300 to second mount 32.

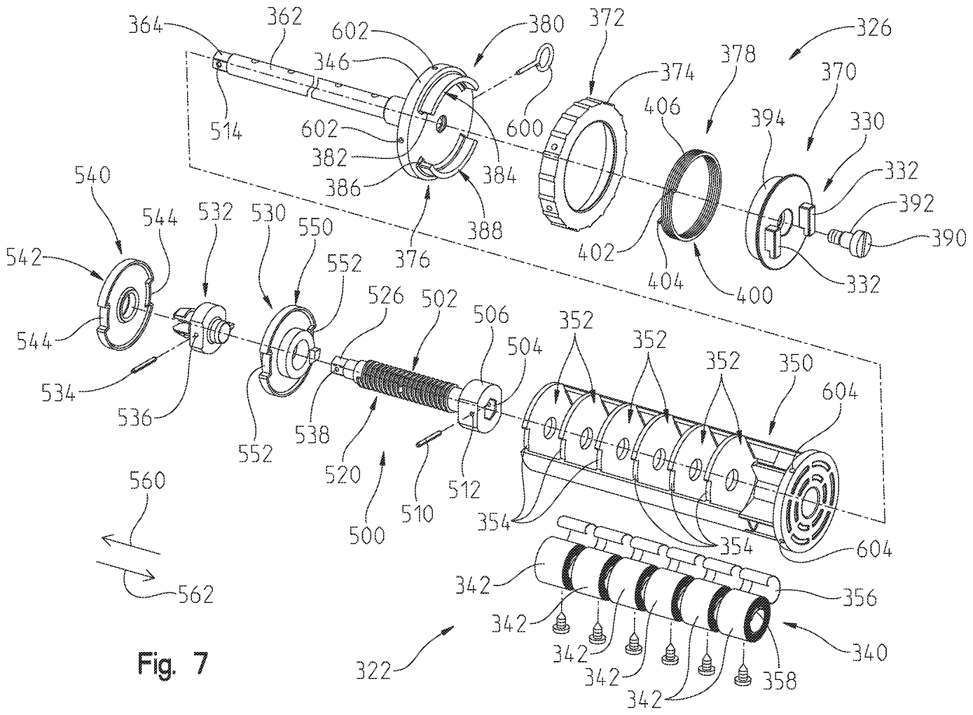

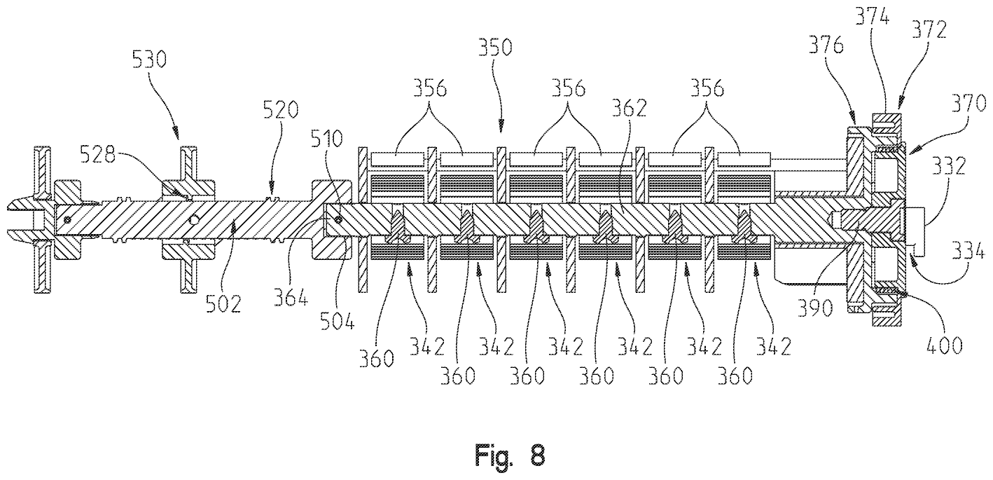

Referring to FIGS. 7 and 8, torque generator 322 includes a plurality of biasing members 340, illustratively clock springs 342. Clock springs 342 are carried by a carriage 350. Carriage includes a separate compartment 352 from each clock spring 342. Further, carriage 350 includes recesses 354 which engage with an internal feature (not shown) of roller tube 320 so that carriage 350 rotates with roller tube 320. A first end 356 (one marked) of clock springs 342 engage carriage 350 (see FIG. 6A). A second end 358 (one marked) of clock springs 342 are secured with fasteners 360 to an elongated shaft 362 (see FIG. 8) As explained herein, elongated shaft 362 is held stationary when roller tube 320 and hence carriage 350 rotate. As roller tube 320 rotates in a first direction to extend window covering 302 and lower hem bar 304, the tension in clock springs 342 increases which increases the torque clock springs 342 exert on roller tube 320 which is needed to maintain a position of lower hem bar 304 once lower hem bar 304 is let go by the operator due to the increased hanging weight of window covering 302 off of roller tube 320. As roller tube 320 rotates in a second direction, opposite the first direction, to retract window covering 302 and raise lower hem bar 304, the tension in clock springs 342 decreases which decreases the torque clock springs 342 exert on roller tube 320 which is allowed due to the decreased hanging weight of window covering 302 off of roller tube 320.

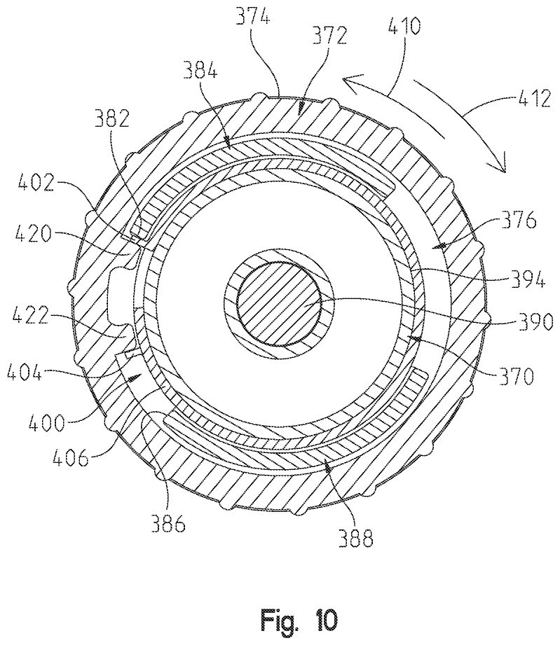

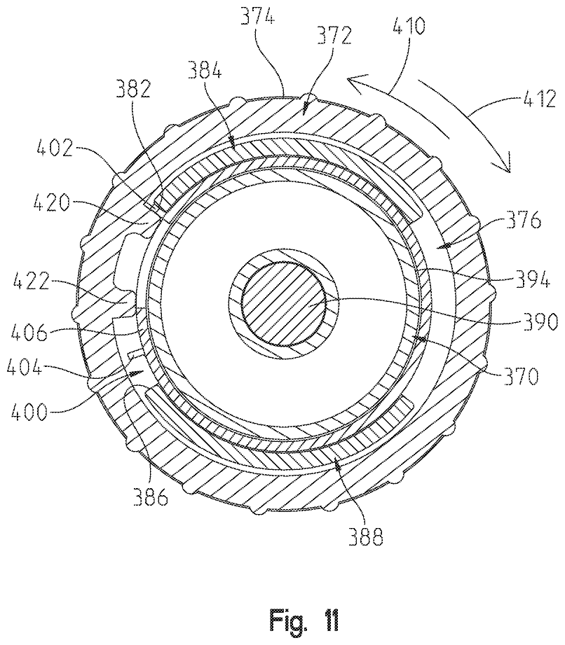

Returning to FIG. 7, torque adjustment input 326 includes a base 370 coupled to first mount 330, an adjuster 372 including an operator actuatable input 374 rotatable relative to base 370, an output 376 which is operatively coupled to biasing members 340 of torque generator 322 and rotatable relative to base 370, and a lock 378 movable by adjuster 372 between an unlocked position (see FIG. 11) wherein output 376 is rotatable relative to base 370 and a locked position (see FIG. 10) wherein output 376 is held relative to base 370. First mount 330 is shown being integral with base 370. In embodiments, first mount 330 is removably coupled to base 370.

Output 376 of torque adjustment input 326 includes elongated shaft 362 which as shown in FIG. 8 extends completely longitudinally through carriage 350. Elongated shaft 362 is operatively coupled to the biasing members 340 of first mount 330 within a longitudinal extent of carriage 350. Output 376 further includes a support wheel 380 coupled to elongated shaft 376. Support wheel 380 includes at least one stop surface, illustratively stop surface 382 of wall 384 and stop surface 386 of wall 388, which as described herein are engageable by lock 378.

Base 370 is coupled to support wheel 380 of output 376 with a fastener 390. In the illustrated embodiment, fastener 390 is a shoulder bolt having a shoulder 392 which allows fo 390 and output 376 to rotate relative to base 370 when coupled together. Base 370 further includes a radial surface 394 which is engageable by lock 378. In embodiments, base 370 may include stop surface 382 of wall 384 and stop surface 386 of wall 388 and support wheel 380 may include radial surface 394.

Lock 378 is illustratively a torsion spring 400 having a first end tang 402 and a second end tang 404. Adjuster 372 is rotatable relative to base 370 and engageable with lock 378 to alter the torque of biasing members 340.

The operation of lock 378 is explained with reference to FIGS. 10 and 11. FIG. 10 illustrates lock 378 in the locked position which is the standard position for torque adjustment input 326. In the locked position windings 406 of torsion spring 400 are in an unsprung configuration contacting radial surface 394 of base 370 and applying pressure to radial surface 394 of base 370 to prevent torsion spring 400 from rotating relative to base 370. Further, stop surface 382 of output 376 is contacting first end tang 402. Without torsion spring 400 being prevented from rotating relative to base 370 due to the interaction between windings 406 of torsion spring 400 and radial surface 394 of base 370, output 376 would continue to rotate torsion spring 400 in direction 410 to relieve tension on biasing members 340.

Adjuster 372 carries an actuator 420 and an actuator 422 which are positioned between first end tang 402 and second end tang 404 of torsion spring 400. Rotating adjuster 372 in either direction 410 or direction 412 results in a separation between first end tang 402 and second end tang 404 increasing which also increases an internal diameter of windings 406 of torsion spring 400 spacing windings 406 from radial surface 394 of base 370 (see FIG. 11). FIG. 11 illustrates lock 378 in the unlocked position wherein windings 406 of torsion spring 400 are in a sprung configuration spaced apart from radial surface 394 of base 370 to permit torsion spring 400 to rotate relative to base 370 as base 370 is further rotated, such as in direction 412 in FIG. 11. As shown in FIG. 11, due to the contact between actuator 420, tang 402, and stop surface 382 of output 376, the rotation of adjuster 372 further in direction 412 due to an operator input on operator actuatable input 374 causes output 376 to rotate relative to base 370 thereby increasing the torque on biasing members 340. When the operator releases operator actuatable input 374 of adjuster 372, adjuster 372 rotates in direction 410 a short distance allowing the separation between first end tang 402 and second end tang 404 to reduce and thereby resulting in locked position windings 406 of torsion spring 400 once again contacting and applying pressure to radial surface 394 of base 370. With torsion spring 400 once again applying pressure to radial surface 394 of base 370, the position of output 376 relative to base 370 is locked and the torque setting of biasing members 340 has been updated. In a similar fashion adjuster 372 may be rotated in direction 410 to separate first end tang 402 and second end tang 404 of torsion spring 400 such that actuator 422 of adjuster 372 can push second end tang 404 into contact with stop surface 386 of wall 388 and cause a rotation of output 376 in direction 410.

Referring to FIG. 7, roller tube assembly 300 further includes a travel limiter 500. Travel limiter 500 includes an elongated shaft 502 having a receiver 504 to receive an end 364 of elongated shaft 362 of output 376. End 364 and receiver 504 are keyed to prevent relative rotation of elongated shaft 502 relative to elongated shaft 362. Elongated shaft 502 is secured to elongated shaft 362 with a pin 510 that is received in holes 512 and 514 of travel limiter 500 and end 364 respectively.

Elongated shaft 502 further includes a threaded section 520 which is threadably engaged with threads 528 (see FIG. 8) of a traveling nut 530. On a second end 526 of elongated shaft 502 a support 532 is coupled thereto with a pin 534 received in holes 536 and 538 in support 532 and second end 526 of elongated shaft 502, respectively. Support 532 is further coupled to a roller tube support 540. Roller tube support 540 includes an outer periphery 542 that generally matches the inner periphery of roller tube 320 and similar to carriage 350 includes recesses 544 that receive internal features of roller tube 320 to key roller tube support 540 to roller tube 320. Roller tube support 540 is rotated relative to support 532 and rotates with roller tube 320 while support 532 remains stationary relative to roller tube 320 due to a fixed connection with base 370 through output 376 and elongated shaft 502.

Traveling nut 530 includes an outer periphery 550 that generally matches the inner periphery of roller tube 320 and similar to roller tube support 540 includes recesses 552 that receive internal features of roller tube 320 to key roller tube support 540 to roller tube 320.

Traveling nut 530 rotates with roller tube 320 and as it does moves relative to elongated shaft 502 in one of direction 560 and direction 562 depending on the rotation direction of roller tube 320 due to the engagement between threaded section 520 of elongated shaft 502 and threads 528 of traveling nut 530.

Referring to FIG. 6B, traveling nut 530 includes a first stop 570 facing carriage 350 and a second stop 572 facing roller tube support 540. A head 506 of elongated shaft 502 includes a third stop 574 facing traveling nut 530 and support 532 includes a fourth stop 576 facing traveling nut 530. As traveling nut 530 advances in direction 560 due to a rotation of roller tube 320 in direction 564 a limit of travel and hence a limit of rotation of roller tube 320 occurs when a lower surface of second stop 572 of traveling nut 530 contacts an upper surface of fourth stop 576 of support 532. Similarly, as traveling nut 530 advances in direction 562 due to a rotation of roller tube 320 in direction 566 a limit of travel and hence a limit of rotation of roller tube 320 occurs when an upper surface of first stop 570 of traveling nut 530 contacts a lower surface of third stop 574 of elongated shaft 502.

As shown in FIG. 6B and FIG. 7, a retainer 600 is received in one of a plurality of openings 602 in a wall 396 of output 376 and passes into one of a plurality of recesses 604 in carriage 350. Retainer 600 prevents the rotation of output 376 relative to carriage 350 to maintain tension on biasing members 340. In operation, retainer 600 is removed, but prior to installation retainer 600 is present as shown in FIG. 6B. Further, if roller tube assembly 300 is to be removed from first mount 30 and second mount 32, pin should be reinserted to again lock a rotational position of output 376 relative to carriage 350.

In embodiments, a method of installing roller tube 320 comprises the steps of: coupling the first mount 330 of roller tube 320 to first mount 30, the first mount 330 being non-rotatable relative to first mount 30; coupling the second mount of roller tube assembly 300 to second mount 32; and removing retainer 600 holding a position of a first portion of roller tube assembly 300 coupled to a first end of biasing members 340 (carriage 350) relative to a second portion of roller tube assembly 300 coupled to a second end of biasing members 340 (output 376). In embodiments, the method further comprises the step of adjusting a torque level of the torque generator 322 relative to the roller tube 320. In embodiments, the step of adjusting the torque level of the torque generator 322 relative to the roller tube 320 includes the step of moving the operator actuatable input 374 relative to the roller tube 320. In embodiments, the step of moving the operator actuatable input relative 374 to the roller tube 320 includes the step of rotating the operator actuatable input 374 relative to the roller tube 320.

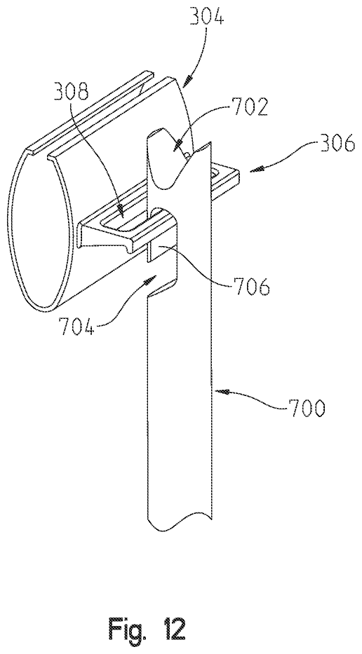

Referring to FIG. 12, in embodiments, lower hem bar 304 includes a handle 306 which may be grasped by an operator to raise or lower hem bar 304 and hence window covering 302. In embodiments, handle 306 is positioned on a window side of lower hem bar 304, on a room side of lower hem bar 304, or two handles 306 with one positioned on a window side of lower hem bar 304 and one on a room side of lower hem bar 304.

In the illustrated embodiment, handle 306 includes an opening 308 which may be engaged by a tool 700 to assist in raising or lowering lower hem bar 304 and hence window covering 302. A top end of tool 700 includes a recess 702 which may engage a lower side of handle 306 to assist in raising lower hem bar 304 by a first portion of recess 702 being received in opening 308. Tool 700 further includes a recess 704 with a hook 706 which may engage an upper side of handle 306 with hook 706 extending through opening 308 of handle 306 to assist in lowering lower hem bar 304.

While embodiments have been described as having exemplary designs, the present disclosure may be further modified within the spirit and scope of this disclosure. This application is therefore intended to cover any variations, uses, or adaptations of the disclosure using its general principles. Further, this application is intended to cover at least such departures from the present disclosure as come within known or customary practice in the art to which this disclosure pertains and which fall within the limits of the appended claims.

What is claimed is:

1. A roller tube assembly for supporting a window covering between a first window covering bracket and a second window covering bracket, the roller tube assembly comprising:
a roller tube adapted to have the window covering rolled onto to raise the window covering and rolled off of to lower the window covering;
a torque generator coupled to the roller tube and including a plurality of biasing members positioned within the roller tube;
a torque adjustment input operatively coupled to the torque generator and including an operator actuatable input engageable from outside of an envelope of the roller tube;
a first mount supporting a first end of the roller tube and adapted to be removably coupled to the first window covering bracket; and
a second mount supporting a second end of the roller tube and adapted to be removably coupled to the second window covering bracket, wherein the roller tube, the torque generator, the torque adjustment input, the first mount, and the second mount are a preassembled unit that is adapted to be coupled to the first window covering bracket and the second window covering bracket.

2. The roller tube assembly of claim 1, wherein the torque adjustment input is positioned between a first extreme outer end of the first mount and a second extreme outer end of the second mount.

3. The roller tube assembly of claim 1, wherein the torque adjustment input is positioned proximate the first mount and the first mount includes a plurality of spaced part interfaces which cooperate with corresponding spaced apart interfaces on the first window covering bracket.

4. The roller tube assembly of claim 3, wherein each of the plurality of spaced apart interfaces of the first mount are in a non-intersecting relationship with a longitudinal axis of the roller tube.

5. The roller tube assembly of claim 1, the torque adjustment input comprising:
a base coupled to the first mount;
an adjuster including the operator actuatable input rotatable relative to the base;
an output operatively coupled to the plurality of biasing members of the torque generator and rotatable relative to the base; and
a lock movable by the adjuster between an unlocked position wherein the output is rotatable relative to the base and a locked position wherein the output is held relative to the base.

6. The roller tube assembly of claim 5, wherein one of the base and the output includes a radial surface engaged by the lock when the lock is in the locked position and the other of the base and the output includes at least one stop engaged by the lock in the unlocked position.

7. The roller tube assembly of claim 6, wherein the at least one stop engaged by the lock in the locked position to hold a position of the output relative to the base.

8. The roller tube assembly of claim 5, wherein the adjuster includes a wheel surrounding the longitudinal axis of the roller tube, an outer circumference of the wheel being the operator actuatable input and an actuator carried by the wheel, the actuator engaging the lock to move the lock from the locked position to the unlocked position.

9. The roller tube assembly of claim 8, wherein the lock includes a torsion spring positioned about the base, the torsion spring having a sprung configuration corresponding to the unlocked position wherein the torsion spring is rotatable relative to the base and an unsprung configuration corresponding to the locked position wherein the torsion spring is held stationary relative to the base.

10. The roller tube assembly of claim 5, further comprising a carriage which supports the plurality of biasing members of the torque generator and wherein the output of the torque adjustment input includes an elongated shaft which extends through the carriage and is operatively coupled to the plurality of biasing members of the torque generator within a longitudinal extent of the carriage and a support wheel coupled to the elongated shaft and including at least one stop surface engageable by the lock.

11. The roller tube assembly of claim 10, wherein the carriage is rotatable with the roller tube relative to the torque adjustment input.

12. The roller tube assembly of claim 11, wherein the base includes a radial surface engaged by the lock when the lock is in the locked position and the at least one stop of the support wheel of the output is engaged by the lock in both the unlocked position and the locked position, in the locked position the at least one stop holds a position of the output relative to the base.

13. The roller tube assembly of claim 12, wherein the adjuster includes a wheel surrounding the longitudinal axis of the roller tube, an outer circumference of the wheel being the operator actuatable input and an actuator carried by the wheel, the actuator engaging the lock to move the lock from the locked position to the unlocked position.

14. The roller tube assembly of claim 13, wherein the lock includes a torsion spring positioned about the base, the torsion spring having a sprung configuration corresponding to the unlocked position wherein the torsion spring and the output are rotatable relative to the base and an unsprung configuration corresponding to the locked position wherein the torsion spring and the output are held stationary relative to the base.

15. The roller tube assembly of claim 14, further comprising a travel limiter coupled to the roller tube, the travel limiter including a threaded shaft received in the roller tube, a stop coupled to the threaded shaft, and a traveling stop threadably engaged with the threaded shaft and coupled to the roller tube to rotate with the roller tube.

16. The roller tube of claim 15, wherein the threaded shaft is coupled to the torque adjustment input and rotatable with the output of the torque adjustment input.

17. A method of installing the roller tube assembly of claim 1, comprising the steps of:
coupling the first mount to the first window covering bracket, the first mount being non-rotatable relative to the first window covering bracket;
coupling the second mount to the second window covering bracket; and
removing a retainer holding a position of a first portion of the roller tube assembly coupled to a first end of the plurality of biasing members relative to a second portion of the roller tube assembly coupled to a second end of the plurality of biasing members.

18. The method of claim 17, further comprising the step of:
adjusting a torque level of the torque generator relative to the roller tube.

19. The method of claim 18, wherein the step of adjusting the torque level of the torque generator relative to the roller tube includes the step of:
moving the operator actuatable input relative to the roller tube.

20. The method of claim 18, wherein the step of moving the operator actuatable input relative to the roller tube includes the step of:
rotating the operator actuatable input relative to the roller tube.
